(19) United States
(12) Patent Application Publication
(10) Pub. No.: US 2004/0018114 A1
(43) Pub. Date: Jan. 29, 2004

(54) Test strip holder for a reagent test strip

(76) Inventors: Chia-Lin Wang, San Diego, CA (US); Jinn-Nan Lin, San Diego, CA (US)

Correspondence Address: FOLEY & LARDNER, P.O. BOX 80278, SAN DIEGO, CA, 92138-0278, US

(21) Appl. No.: 10/205,710

(22) Filed: Jul. 26, 2002

(51) Int. Cl. G01N 31/22; B01L 3/00

(52) U.S. Cl. 422/55; 422/58; 422/102; 422/104

(57) ABSTRACT

A test strip holder for a reagent test strip, the reagent test strip having a proximal portion, a distal portion, and a reaction zone, the test strip holder including a base including a detection aperture, an engaging means able to engage the distal portion, the engaging means including a first deflection surface able to deflect the distal portion in a first direction, and a second deflection surface able to deflect the distal portion in a second direction. Preferably the reaction zone is in approximate or substantial alignment with the detection aperture when the distal portion is fully engaged.

### TECHNICAL FIELD

The present invention relates generally to devices that secure test strips to metering devices. More specifically the present invention relates to a test strip holder for engaging a reagent test strip to a test meter.

### BACKGROUND

Reagent test strips are frequently used with test meters to detect the presence or concentration of an analyte in a variety of fluids. Reagent test strips are generally placed on test meters such that the reaction zone is detected through a detection aperture. For example diabetic patients regularly utilize reagent test strips and test meters to determine the presence or concentration of glucose in a sample of whole blood. In this instance the patient must handle a test meter while applying a sample. Because reagent test strips are used frequently, needs in test strip holder development have included developing devices that allow the user to easily and effectively engage a reagent test strip to the test meter and that allow the easy and effective alignment of a test strip with a detection aperture. The present invention addresses these needs and provides related benefits.

### BRIEF DESCRIPTION OF THE DRAWINGS

FIG. 1A depicts a perspective view of one aspect of the test strip holder of the present invention.

FIG. 1B depicts a perspective view of the test strip holder of FIG. 1A attached to a test meter.

FIG. 2 depicts a top view of the test strip holder of FIG. 1A.

FIG. 3A depicts a side cutaway view of the test strip holder of FIG. 1A along 17 and through 12, such as through A-A of FIG. 4A.

FIG. 3B depicts the side cutaway view of the test strip holder of FIG. 3A enlarging the view of 13, 14, 15 and 18 and demonstrating the engaging means and strip impeding means.

FIG. 3C depicts a side cutaway view of the test strip holder of FIG. 1A along 17 and through 12 such as through A-A of FIG. 4A with an engaged reagent test strip.

FIG. 3D depicts a side cutaway view of the test strip holder of FIG. 3C attached to a test meter with an engaged test strip.

FIG. 4A depicts a top view of the test strip holder of FIG. 1A demonstrating the approximate position of the cutaway for FIG. 4B along B-B and FIG. 4C along C-C.

FIG. 4B depicts a front cutaway view of the distal portion of the test strip holder of FIG. 1A along B-B.

FIG. 4C depicts a front cutaway view of the center and proximal portions of the test strip holder of FIG. 1A.

FIG. 5 depicts a bottom view of the test strip holder of FIG. 1A.

### SUMMARY

The present invention recognizes that goals in test strip holder development should include devices that allow a user to easily and effectively engage a reagent test strip to a test meter. The present invention addresses these goals and provides related benefits.

The present invention includes but is not limited to a test strip holder for a reagent test strip, the reagent test strip having a proximal portion, a distal portion, and a reaction zone, the test strip holder including a base including a detection aperture, an engaging means or structure able to engage the distal portion, the engaging means including a first deflection surface able to deflect the distal portion in a first direction, and a second deflection surface able to deflect the distal portion in a second direction. Optionally the reaction zone is in approximate or substantial alignment with the detection aperture when the distal portion is fully engaged in the engaging means. Optionally the base includes an indicating means or structure for indicating the reaction zone is in approximate or substantial alignment with the detection aperture. Optionally the test strip holder includes a guiding means or structure able to accept a reagent test strip. Optionally the guiding means or structure guides the reagent test strip towards the engaging means or structure. Optionally the test strip holder includes a strip impeding means or structure for impeding the distal portion after the distal portion is fully engaged in the engaging means or structure. Optionally, the test strip holder includes an attachment means or structure for attaching the test strip holder to a test meter. Optionally the test strip holder includes a support surface able to support the proximal portion of the reagent test strip. Optionally the test strip holder may be reversibly affixed to a test meter.

The present invention also includes a test strip holder for a reagent test strip, the reagent test strip having a proximal portion, a distal portion, and a reaction zone, the test strip holder including a base including a detection aperture, and an indicating means or structure for indicating the reaction zone is in approximate or substantial alignment with the detection aperture.

Definitions

Unless defined otherwise, all technical and scientific terms used herein have the same meaning as commonly understood by one of ordinary skill in the art to which this invention belongs. Generally, the nomenclature used herein and the manufacture or laboratory procedures described below are well known and commonly employed in the art. Conventional methods are used for these procedures, such as those provided in the art and various general references. Terms of orientation such as “up” and “down” or “upper” or “lower” and the like refer to orientation of the parts during use of the device. Where a term is provided in the singular, the inventors also contemplate the plural of that term. The nomenclature used herein and the laboratory procedures described below are those well known and commonly employed in the art. As employed throughout the disclosure, the following terms, unless otherwise indicated, shall be understood to have the following meanings:

The term “proximal” as used herein refers to a portion or end nearest the user. A proximal end or proximal portion of a reagent test strip is the end or portion a user touches when inserting the reagent test strip in the test strip holder. The proximal end is separated by the distal end by a reaction zone. The proximal end or proximal portion of the test strip holder is the end or portion furthest from the engaging means when the reagent test strip is properly engaged with the test meter.

The term “distal” as used herein refers to a portion farthest from the user. A distal end or distal portion of a reagent test strip is the end or portion farthest from a user's hand when engaging the reagent test strip with a test meter. The distal end or distal portion is engaged in the engaging means preventing or reducing movement of the reagent test strip.

The term “reaction zone” as used herein refers to a portion of a reagent test strip where a sample is applied, migrates through, is measured or any combination thereof. The reaction zone may include a single membrane, a series of membranes or other support layers. The reaction zone is positioned between the proximal portion of the reagent test strip and the distal portion of the reagent test strip. When the reagent test strip is properly and fully engaged with the test strip holder the reaction zone is substantially or approximately aligned with the detection aperture such that a test meter may access the reaction zone of the reagent test strip.

Other technical terms used herein have their ordinary meaning in the art that they are used, as exemplified by a variety of technical dictionaries.

### DESCRIPTION OF THE PREFERRED EMBODIMENTS

The present invention recognizes that test strip holder development should include devices that allow a user to easily and effectively engage a reagent test strip to a test meter. The present invention also recognizes the need for a test strip holder that allows easy and effective alignment of a detection aperture with a reaction zone. The present invention provides such a device and methods of use.

As a non-limiting introduction to the breath of the present invention, the present invention includes several general and useful aspects, including a test strip holder 10 for a reagent test strip, the reagent test strip having a proximal portion, a distal portion, and a reaction zone, the test strip holder 10 including a) a base 11 including a detection aperture 12; b) an engaging means 13 able to engage the distal portion, the engaging means 13 including i) a first deflection surface 14 able to deflect the distal portion in a first direction; ii) a second deflection surface 15 able to deflect the distal portion in a second direction; and wherein the reaction zone is in approximate or substantial alignment with the detection aperture 12 when the distal portion is fully engaged.

The present invention also includes test strip holder 10 for a reagent test strip, the reagent test strip having a proximal portion, a distal portion, and a reaction zone, the test strip holder 10 including a) a base 11 including a detection aperture 12; and b) an indicating means 16 for indicating the reagent test strip is in approximate or substantial alignment with the detection aperture.

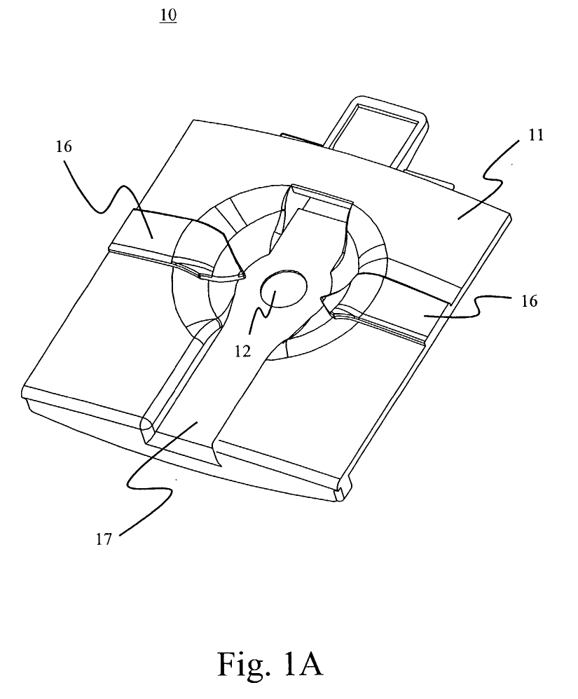

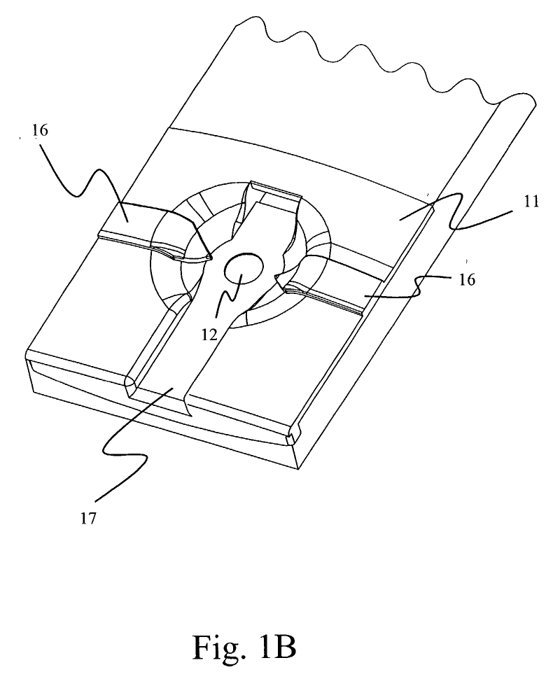

Referring to FIG. 1A the base 11 may provide the primary support for a reagent test strip and a structure for the user to handle the test strip holder 10. The base 11 should be able to accept and support the weight of a reagent test strip. The base 11 should be sufficiently rigid such that it significantly retains its shape when physically manipulated by the user such as when attaching the test strip holder to a test meter. Examples of suitable materials for constructing a base are polypropylene, polystyrene and other polymers or plastics, although other appropriate solid or semi-solid materials can be used as well. The base 11 may be constructed in a variety of geometric or non-geometric shapes, such as generally rectangular, oval, triangular or kidney shaped. FIG. 1B depicts one preferred aspect of the present invention attached to a test meter. The left side and right side are substantially the same. The rear is also depicted. Because test meters may be available in different shapes the shape and dimensions of the base 11 may vary depending on the test meter such that the test strip holder 10 and test meter may have complimentary surfaces.

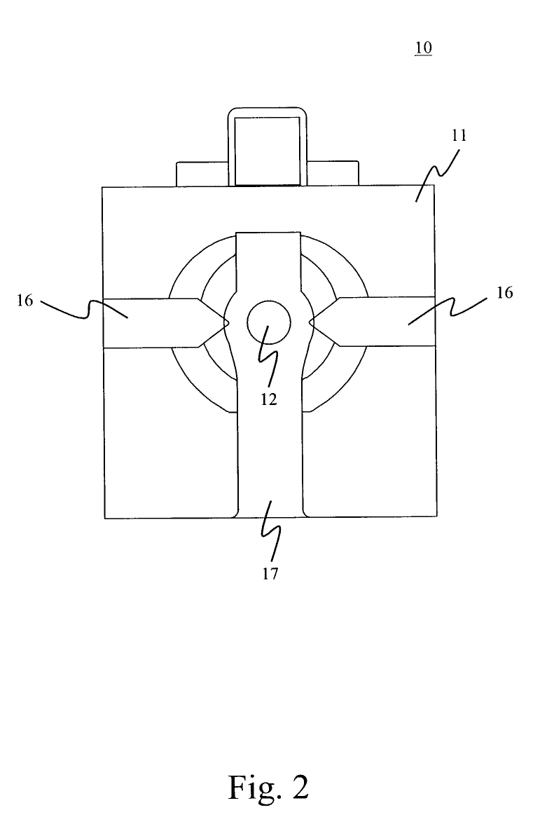

Referring to FIG. 2 the base 11 includes a detection aperture 12. The detection aperture 12 provides a path such that a test meter may detect a signal from the reaction zone of the reagent test strip. The size of the detection aperture 12 should be sufficiently large that the test strip holder 10 does not significantly obstruct a test meter from detecting the reaction zone of an engaged reagent test strip.

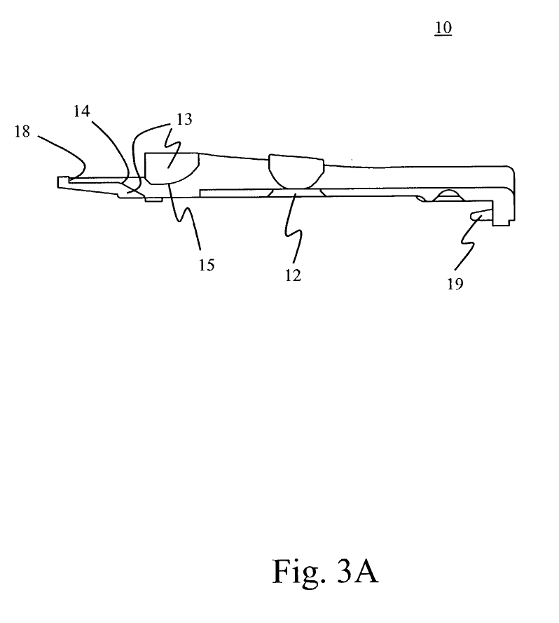

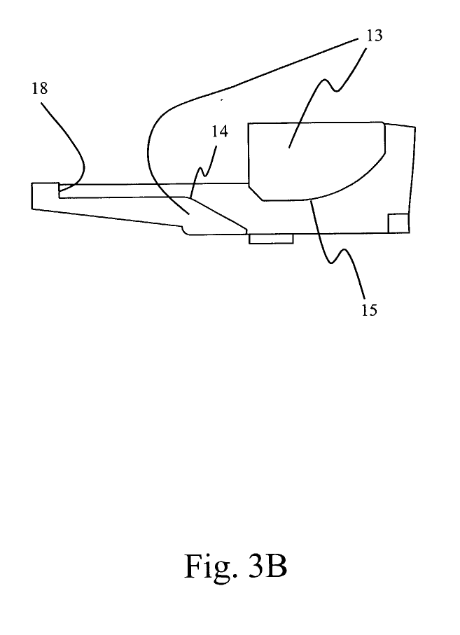

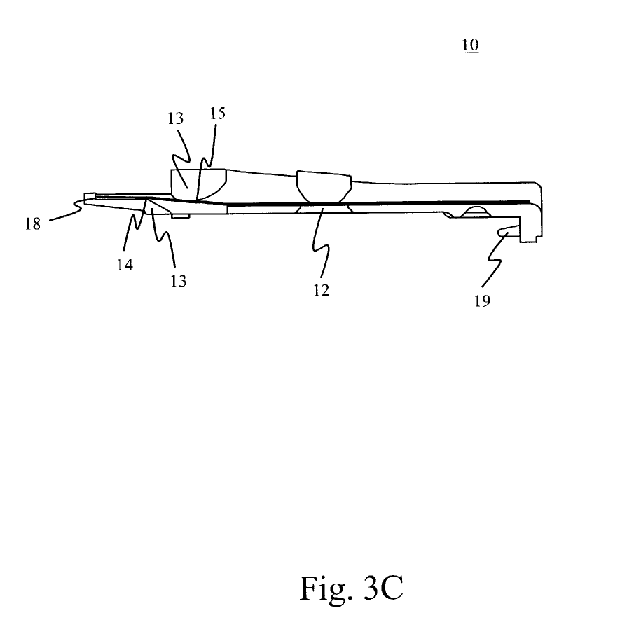

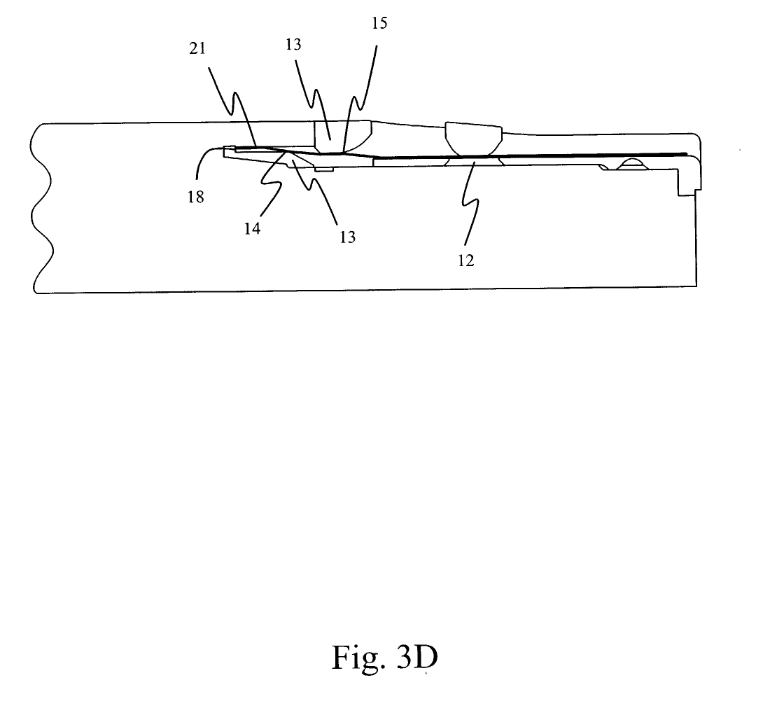

Referring to FIGS. 3A-3D the engaging means 13 engages the distal portion and may substantially restrict movement of the reagent test strip away from the detection aperture 12. An engaged distal portion may also cause the reagent test strip to exert a force towards the base 11 thereby allowing the reaction zone to lie generally flat along the detection aperture 12. The engaging means may also function to retain contact between the reagent test strip and the base. The engaging means 13 includes a first deflection surface 14 and a second deflection surface 15 in substantial or approximate alignment and is positioned at about the distal end of the test strip holder 10. The engaging means 13 may be positioned within the general area of the base 11 or may extend from the distal portion of the base 11. When extending from the base 11 the engaging means 13 may be able to accept a test meter cavity such that the engaging means 13 assists in the attachment of the test strip holder 10 to the test meter. The engaging means 13 may be constructed from any material able to withstand the force exerted by a deflected reagent test strip. Suitable examples are polypropylene, polystyrene and other polymers or plastics, although other suitable solid or semi-solid materials can be used as well. The engaging means 13 may be cast separately and affixed to the base 11 or may be molded together with the base 11 in a single cast.

The first deflection surface 14 may include a surface angled generally upward. The first deflection surface may also include a substantially horizontal portion, recessed portion or both. The substantially horizontal portion or recessed portion may be in contact with an engaged distal portion of a reagent test strip.

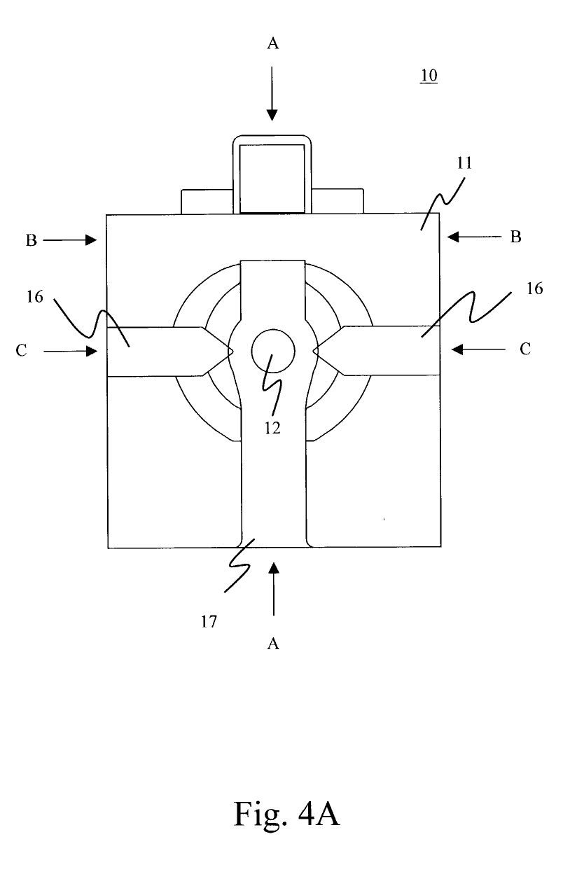

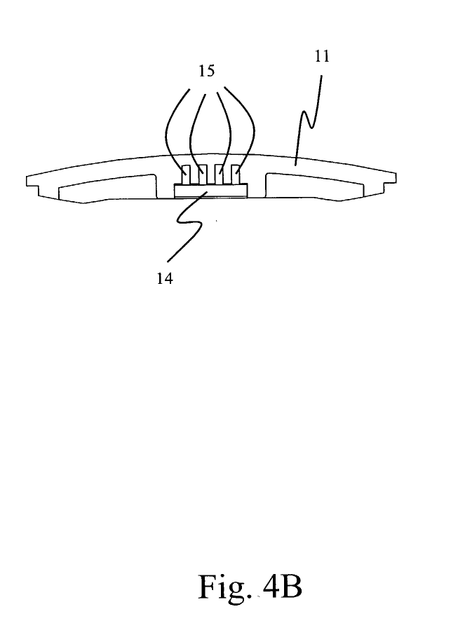

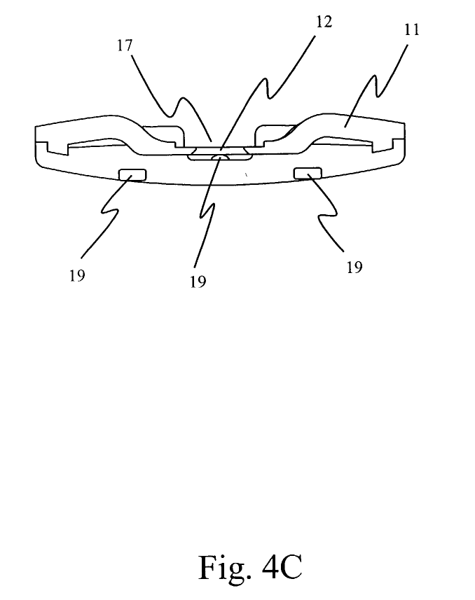

Using the cutaway depicted in FIG. 4A at B-B, FIG. 4B is a front view of the distal portion of the test strip holder and FIG. 4C is a front view of the center and proximal portions of the test strip holder. Referring to FIG. 4B a second deflection surface 15 is shown having multiple surfaces protruding generally downward in substantial or approximate alignment with one another. In this configuration the multiple surfaces may contact the distal portion of a reagent test strip at about the same time. Alternatively, the second deflection surface 15 may include a single surface.

Referring again to FIG. 3C and FIG. 3D engaging a reagent test strip may involve slidably inserting the distal portion of the reagent test strip into the engaging means 13 until the reaction zone of the reagent test strip is in substantial or approximate alignment with the detection aperture 12. The forces exerted from the deflected distal portion against the first 14 and second deflection surfaces 15 substantially reduce undesirable movement of the reagent test strip.

In one aspect of the present invention, as the distal portion is slidably inserted into the engaging means 13, the distal portion may contact and slide along the second deflection surface 15 as depicted in FIG. 3B. The distal portion then contacts the first deflection surface 14. The first deflection surface 14 deflects the distal portion in a first direction such as generally upwards causing the distal portion to flex. Flexing causes the second deflection surface 15 to deflect a remote region of the distal portion in a second direction. The second direction is a different direction than the first direction such as generally downward or generally parallel to the surface of the base 11. The user adjusts the positioning of the reagent test strip until the detection zone is in substantial or approximate alignment with the detection aperture 12.

Alternatively the distal portion may be deflected by the second deflection surface 15 prior to deflection of the first surface 14. The distal portion is slidably inserted into the engaging means 13 and the second deflection surface 15 deflects the distal portion in the second direction. Insertion continues and the first deflection surface 14 deflects the distal portion in the first direction. The user adjusts the positioning of the reagent test strip such that the detection zone is in substantial or approximate alignment with the detection aperture 12.

Preferably when the test strip holder 10 is attached to a test meter as depicted in FIG. 3D, engaging a reagent test strip includes deflecting the distal portion in the first, second and a third direction. Deflecting the distal portion in the third direction occurs after deflection in the first direction and may occur before or after deflection in the second direction. Preferably a test meter surface 21 deflects the distal portion in the third direction.

Referring to FIG. 2 the base 11 may include an indicating means 16 for indicating a reagent test strip is properly inserted in the test strip holder 10. The indicating means 16 may be in a variety of configurations, such as at least one arrow pointing towards the detection aperture 12 or markings that align with complimentary markings on a reagent test strip when a reagent test strip is properly inserted. In the first configuration the indicating means 16 includes at least one arrow pointing generally towards the direction of the detection aperture 12. In this configuration the user visually aligns the reaction zone of a reagent test strip with the at least one arrow thereby indicating the reaction zone is in substantial or approximate alignment with the detection aperture 12. In the latter configuration, the user aligns the at least one marking on the base 11 with a complimentary marking on the reagent test strip. In this configuration, the placement of the at least one marking on the base 11 and the complimentary marking on the reagent test strip are such that their alignment results in substantial or approximate alignment of the reaction zone with the detection aperture 12.

The base 11 may include a guiding means 17 for guiding a reagent test strip towards the engaging means 13. The guiding means 17 may be physically distinct from the surface of the base 11 such as a groove or an elevated surface able to accept a reagent test strip. The guiding means 17 may extend from about the distal portion of the base 11 to the proximal portion of the base 11 or may extend from about the distal portion of the base and end prior to the proximal end of the base 11.

In the first configuration the guiding means extends from about the distal portion of the base to the proximal portion of the base 11. In this configuration the majority of the guiding means 17 may be in contact with an engaged reagent test strip. The general shape of the guiding means 17 should generally conform to the shape of a reagent test strip. However a guiding means 17 may also include additional features such as an expanded area about the detection aperture 12. The expanded area may allow easier access when placing a drop of blood from a pricked finger on the reaction zone of a reagent test strip. The shape of the expanded area may be any shape such as generally circular, generally triangular or generally finger shaped.

In the second configuration the guiding means 17 extends from about the distal portion of the base 11 and ends prior to the proximal end of the base 11. This configuration may be preferred when using a reagent test strip having at least one spacer such that the spacer elevates the reaction zone from the base 11. In this configuration the base 11 may suspend the proximal portion of the reagent test strip and a recessed guiding means 17 may be about the same depth as the height of the spacers.

Alternatively the guiding means 17 may be a visually distinct portion of the base 11 such as at least one arrow pointing generally towards the engaging means 13. In this configuration the guiding means indicates to the user the direction of insertion into the engaging means 13.

Referring to FIGS. 3A-3D the test strip holder 10 may include a strip impeding means 18 able to impede the insertion of the distal portion. The impeding means 18 may be positioned such that the distal portion is in contact with the impeding means 18 when the reaction zone is in substantial or approximate alignment with the detection aperture 12 or may be positioned such that aligning the detection zone with the detection aperture 12 requires no contact between the impeding means 18 and the reagent test strip. The impeding means 18 may be constructed from any material able withstand the force exerted from a distal portion slidably inserted into an engaging means 13 such as polypropylene, polystyrene or other polymer plastics. The impeding means 18 may be affixed to the engaging means 13 or may be molded with the engaging means 13.

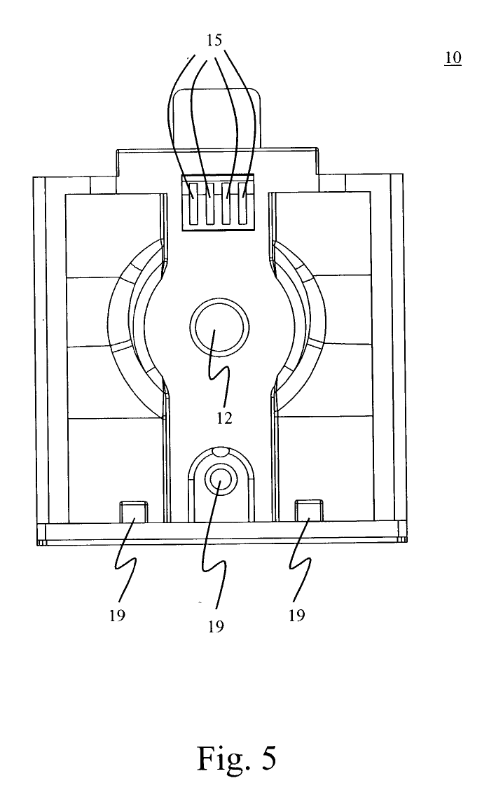

Referring to FIG. 5 the test strip holder 10 may include an attachment means 19 for attaching the test strip holder 10 to a test meter. The attachment means 19 may permanently or preferably reversibly attach the test strip holder 10 to the test meter. The test strip holder 10 may be attached at the test strip holder's distal portion, proximal portion, opposing side portions or any combination thereof. The attachment means 19 may attach the test strip holder 10 to the test meter utilizing a variety of techniques such as complementary male to female adaptors, molded surfaces or snaps. FIG. 4C and FIG. 5 show a variety of complementary male to female adaptors on the same base 11. The present invention also encompasses permanently affixing the test strip holder 10 to the test meter without an attachment means 19 such as by gluing the test strip holder to the test meter.

We claim:

1. A test strip holder for a reagent test strip, said reagent test strip having a proximal portion, a distal portion, and a reaction zone, said test strip holder comprising:
a a base comprising a detection aperture;
b an engaging means able to engage said distal portion, said engaging means comprising:
i a first deflection surface able to deflect said distal portion in a first direction;
ii a second deflection surface able to deflect said distal portion in a second direction; and
wherein said reaction zone is in approximate or substantial alignment with said detection aperture when said distal portion is fully engaged.

2. The test strip holder according to claim 1 wherein said base further comprises an indicating means for indicating said reaction zone is in approximate or substantial alignment with said detection aperture.

3. The test strip holder according to claim 1 wherein said base further comprises a guiding means able to accept a reagent test strip; and further wherein said guiding means guides said reagent test strip towards said engaging means.

4. The test strip holder according to claim 3 wherein said detection aperture is positioned within said guiding means.

5. The test strip holder according to claim 1 further comprising a strip impeding means for impeding said distal portion after said distal portion is fully engaged in said engaging means.

6. The test strip holder according to claim 1 further comprising an attachment means for attaching said test strip holder to a test meter.

7. The test strip holder according to claim 1 further comprising a support surface able to support said proximal portion.

8. The test strip holder according to claim 1 wherein said test strip holder may be reversibly affixed to a test meter.

9. A test strip holder for a reagent test strip, said reagent test strip having a proximal portion, a distal portion, and a reaction zone, said test strip holder comprising:
a a base comprising a detection aperture; and
b an indicating means for indicating said reaction zone is in approximate or substantial alignment with said detection aperture.
